(19) United States
(12) Patent Application Publication
(10) Pub. No.: US 2006/0141418 A1
(43) Pub. Date: Jun. 29, 2006

(54) Method for treating a screw-cement retained prosthesis, abutment and implant for a screw-cement retained prosthesis

(76) Inventor: Young Ku Heo, Seoul (KR)

Correspondence Address: IPLA P.A., 3580 WILSHIRE BLVD., 17TH FLOOR, LOS ANGELES, CA, 90010, US

(21) Appl. No.: 10/544,947

(22) PCT Filed: Mar. 11, 2004
(86) PCT No.: PCT/KR04/00496

§ 371 Date: Aug. 8, 2005

(30) Foreign Application Priority Data
Mar. 13, 2003 (KR) 10-2003-0015619
Mar. 9, 2004 (KR) 10-2004-0015869

(51) Int. Cl. A61C 8/00

(52) U.S. Cl. 433/173

(57) ABSTRACT

A method for treating a screw-cement retained prosthesis, an abutment and an implant are disclosed. The method for treating the screw-cement retained prosthesis, which relates to an internal implant, comprises the steps of providing an abutment comprising a joining projection, repositioning the joining projection to a joining groove formed in the upper portion of a fixture, engaging the abutment to the fixture by using a screw, providing a prosthetic appliance including a screw hole, and bonding the prosthetic appliance and the abutment by interposing dental cement between the abutment and the prosthetic appliance. The present invention includes all of the advantages of screw retained prostheses and cement retained prostheses and at the same time can solve the disadvantages thereof. Using a leading inclined surface formed in the joining projection, the abutment and prosthetic appliance are easily separated from and remounted to the fixture.

### TECHNICAL FIELD

The present invention relates to a dental implant, and more particularly to a method for treating an internal implant wherein it is simple to treat and easy to assemble and disassemble the implant and an abutment and an internal implant for a screw-cement retained prosthesis which is employed in the above treatment method.

### BACKGROUND ART

A dental implant means a dental treating method or an artificial tooth structure that is formed by implanting an artificial dental root in a region where a tooth has been partially or wholly lost, causing the artificial dental root to adhere to an alveolar bone, and fixing a prosthesis or crown to the artificial dental root. Generally, the implant comprises a titanium fixture, an abutment fixed onto the fixture, an abutment screw for fixing the abutment to the fixture, and a prosthesis as an artificial tooth secured to the abutment.

The implant makes it possible to treat only an injured portion without injuring adjacent teeth or tissue around the lost teeth, retards an absorption rate of bone tissue by supporting the bone tissue, and can provides masticatory force and an aesthetic appearance equal to that of natural teeth.

As such, implants have become widely used in dental treatment methods for repairing an injured or lost tooth.

Conventional implants are divided into an external connection type and an internal connection type implants according to the feature of the implants, and divided into a screw retained prosthesis (SRP) and a cement retained prosthesis (CRP) according to a method for treating an implant. Hereinafter, we would describe screw-cement retained prosthesis for an internal connection type.

Screw Retained Prosthesis (SRP)

The screw retained prosthesis has been used from when implants were first developed, and continue to be used today. In the screw retained prosthesis, fundamentally, a finished prosthetic appliance is fixed to an implant with a screw, and the prosthetic appliance can be easily removed or replaced since they are engaged by the screw. There are two types in the screw retained prosthesis. One is a type that is treated by integrally fixing an UCLA abutment and a prosthetic appliance to form a prosthetic assemble, then by mounting the prosthetic appliance directly to a fixture, and the other one is a type that is treated by connecting a fixture and a transmucosal abutment, then by mounting a prosthetic assemble onto the transmucosal abutment, wherein the prosthetic assemble is formed by fixing an upper abutment (gold cylinder) and a prosthetic appliance. However, especially for internal connection type, the UCLA abutments are rarely used.

FIG. 1a is a sectional view of a conventional screw retained prosthesis using an UCLA abutment.

Referring to FIG. 1a, a screw retained prosthesis 10 using an UCLA abutment comprises a fixture 12 implanted into an alveolar bone and an abutment 14, which is formed integrally with a prosthetic appliance 18 and disposed on the fixture 12. The prosthetic appliance 18 and the abutment 14 are integrally formed on the outside and are formed with a hole through the center.

A screw 16 is tightened through the hole to the fixture 12, so that the prosthetic appliance 18 and abutment 14 are fixed to the fixture 12.

FIG. 1b is a sectional view of a conventional screw retained prosthesis using an intermediate abutment.

Referring to FIG. 1b, the screw retained prosthesis 20 using an intermediate abutment comprises a fixture 22, an intermediate abutment 24, and an upper abutment 26, which is formed integrally with a prosthetic appliance 28 and is disposed on the intermediate abutment 24. The intermediate abutment 24 comprises a hole corresponding to a first screw 23, wherein the first screw 23 is engaged through the intermediate abutment 24 to the fixture 22, so that the intermediate abutment 24 is fixed to the fixture 22.

A second screw 25 is inserted through a hole that passes through the prosthetic appliance 28 and the upper abutment 26, and the second screw 25 is engaged to a screw hole formed on an upper portion of the first screw 23, so that the prosthetic appliance 28 and the upper abutment 26 are fixed to the intermediate abutment 24.

As shown in FIGS. 1a and 1b, ready-made articles such as the UCLA abutment 14 and the upper abutment 26, which are fitted to upper portions of the fixture or the intermediate abutment, are housed within lower portions of the finished prosthetic appliances 18, 28 and are integrally formed with the prosthetic appliances when the prosthetic appliances are cast.

A major feature of the screw retained prosthesis is that the screw hole is formed in an occlusal surface of the prosthetic appliance so that engagement between of the screw and the fixture can be adjusted through the screw hole. Therefore, the screw retained prosthesis has advantages as follows:

First, the prosthetic appliance can be easily separated and remounted even after the prosthetic appliance is completed and mounted in an oral cavity.

The prosthetic appliance is easily repaired and remounted only if the prosthetic appliance is separated from the fixture in cases where repair or replacement of the prosthetic appliance is needed due to accidental breakage of the prosthetic appliance, the screw need to be tightened since the screw is loosened of itself, a patient undergoes the treatment and later complains of inconvenience regarding the prosthetic appliance which is mounted to the patient, and some of plural implant fixtures fail.

In such cases, the screw retained prosthesis allows the prosthetic appliance to be very easily separated. That is to say, the prosthetic appliance can be separated without damage by loosening the screw through the screw hole and remounted by tightening the screw.

Second, the screw retained prosthesis makes the treatment possible even when the distance between an implant and a tooth that faces the implant is short For example, the UCLA abutment can only be used if the distance is 5 mm or greater.

However, the screw retained prosthesis also has serious disadvantages instead of satisfying the requisites.

Since the prosthetic appliance should be passively fitted to the fixture of an understructure, the screw retained prosthesis should be manufactured precisely up to its near completion. Therefore, the screw retained prosthesis is complicated to manufacture, and excessive manufacturing time and cost may be required.

Furthermore, if the implant is not completely manufactured and mounted, various stresses can be applied to the implant, so that the excessive stress may often bring about loss of bone around the implant or breakage of the prosthetic appliance or the implant itself.

A problem that often occurs in the screw retained prosthesis is the phenomenon that the screw becomes loose. Some reports say that the screw looseness occurs in about 25˜30% of the screw retained prosthesis. That is to say, compared with a fit implant prosthesis, an unfit implant prosthesis causes the screw to be strained and permanently deformed even by a small biting force, so that the screw is easily loosened.

In order to solve this problem, the screw retained prosthesis should be fixed by passive fit. In order to fabricate the prosthesis with the passive fit in the oral cavity, first a precise working model should be fabricated, and then the prosthesis should be precisely fabricated thereon.

In order to fabricate the exact precise working model, precise impression making, fabrication of the precise working model, and fabrication of the precise prosthetic appliance needs to be performed. However, if contraction, deformation or the like of material is considered, such work requires a high degree of expert training. Also, due to features of the fabricating processes, a great deal of time is needed for treatment and fabrication. Therefore, fabrication as well as treatment costs a great deal, and the cost of materials also increases. Thus, the screw retained prosthesis is very expensive with regard to total costs.

As above mentioned, screw retained prosthesis is difficult to adapt to the internal connection type of multiple implants. Since each of the SRP implants has too long joining projection and too deep joining groove, the abutments of them cannot be separated from the fixtures. So now a day, CRP is mostly applied in multiple internal implants.

Cement Retained Prosthesis (CRP)

Contrary to the screw retained prosthesis, the conventional cement retained prosthesis (CRP) is treated by fixing a cement type abutment to the implant fixture with a screw, disposing a finished prosthetic appliance that is separately fabricated onto the fixed abutment, and bonding the prosthetic appliance and the abutment by interposing dental cement therebetween.

FIG. 2 is a sectional view of the conventional cement retained prosthesis on an external hex implant.

Referring to FIG. 2, the conventional cement retained prosthesis 30 comprises a fixture 32, a cement type abutment 34, and a prosthetic appliance 38. The abutment 34 formed with a screw hole is disposed onto the fixture 32 implanted into the alveolar bone, and then is fixed to the fixture 32 by tightening a screw 36 to the fixture 32 through the screw hole.

The prosthetic appliance 38 is fitted into the fixed abutment 34, and then the abutment 34 and the prosthetic appliance 38 are bonded by interposing dental cement therebetween. Contrary to the screw retained prosthesis, after manufacturing the prosthetic appliance 38 separately from the abutment 34, the prosthetic appliance 38 and the abutment 34 are bonded with the dental cement.

Therefore, the most major feature in appearance, of the conventional cement retained prosthesis is that there is not a screw hole in the occlusal surface of the prosthetic appliance. Therefore, contrary to the screw retained prosthesis, artificial teeth are inconspicuous in appearance, so that the prosthetic appliance can be formed as natural teeth. However, once the prosthetic appliance is mounted cannot be separated by loosening a screw.

The cement retained prosthesis solves all the disadvantages of the screw retained type. That is to say, with the cement retained prosthesis, 1) the passive fit between the fixture and the prosthetic appliance can be easily achieved; 2) as a result, stress applied to the fixture when the prosthetic appliance is connected is reduced; 3) the screw does not often become loose; 4) clinical procedure and manufacturing processes are simple; 5) time can be saved; and 6) manufacturing costs are reduced.

Most of all, the greatest advantage of the cement retained prosthesis is to simply solve the problems caused from an unfit between the prosthetic appliance and the abutment by a space between them and the dental cement interposed. Contrary to the screw retained type, which requires the high degree of precision, the cement retained prosthesis is simple in its impression and manual operational processes and achieves the passive fit between the implant and the prosthetic appliance as long as some fundamental rules are kept.

Due to the above reasons, the cement retained type is preferred to the screw retained type lately.

However, as mentioned above, the cement retained prosthesis has a disadvantage that it is not easy to separate and remount the prosthetic appliance. The sole method to separate the prosthetic appliance from the implant in the cement retained type is to apply an external force. As an example, in a case of single cement retained prosthesis, the screw may be come loose. In this case, even if using temporary cement, it is nearly impossible to remove the prosthetic appliance without damage of the screw threads or the prosthetic appliance. If a prosthesis comprises plural implants that are integrally formed, since retaining force caused by the plural implants is increased, it becomes even more impossible to remove the prosthetic appliance.

Another problem of the cement retained prosthesis is that the treatment is difficult when intermaxillary distance is short. In practice, there are many cases of the short intermaxillary distance. In this case, if using the cement retained type, the length of the abutment becomes short and due to this retaining force is reduced, so that potential for damage or loss of the prosthetic appliance is increased.

Furthermore, still another problem of the cement retained type is that it is difficult to completely remove the cement that remains in the oral cavity after bonding the prosthetic appliance with the cement. If the remaining cement is not completely removed, the remaining cement may cause the implant to fail since inflammation occurs at gingiva around the implant over a long period of time.

On one hand, conventional implants are divided into the screw retained prosthesis (SRP) and the cement retained prosthesis (CRP) according to a method for treating an implant; on the other hand, conventional implants may be divided into an external implant and an internal implant according to their joining structure.

As shown in FIGS. 1a, 1b and 2, the external implant has the structure that a joining projection is formed on the upper end of the fixture 12, 22 or 32 and the abutment 14, 24 or 34 receives the joining projection.

On the contrary, an internal implant has the structure that a joining projection is formed at the lower end of the abutment, and a joining groove for receiving the joining projection is provided in the upper end of the fixture.

FIG. 3 is a sectional view for explaining a conventional internal implant. FIG. 3 shows two kinds of internal implants indicated as (a) and (b), which belong to the cement retained prosthesis (CRP).

Referring to FIG. 3 (a), the internal implant comprises a fixture 42, an internal abutment 44, a screw 46, and a prosthetic appliance 48. The fixture 42 comprises a joining groove in an upper end thereof, and the abutment 44 comprises a joining projection 45 correspondingly to the joining groove. The joining projection 45 is formed in the lower end of a body of the abutment 44, and a bonding portion, which is bonded to prosthetic appliance 48 with dental cement, is formed in the upper end of the body.

The joining groove of the fixture 42 comprises a truncated circular conical groove positioned at an inlet side and a hexagonal cylindrical groove formed at the lower end thereof. The joining projection 45 of the abutment 44 comprises a truncated circular conical sticking portion 45a and a hexagonal cylindrical anti-rotating portion 45b correspondingly to the joining groove. While the joining projection 45 of the abutment 44 is inserted into the fixture 42, the sticking portion 45a supports the body of the abutment 44, and the anti-rotating portion 45b is engaged to the lower portion of the joining groove and then prevents the abutment 44 from rotating with respect to the fixture 42.

However, since the anti-rotating portion 45b is formed in a hexagonal, octagonal, or polygonal cylindrical shape, the abutment 44 must be retracted from the fixture 42 in an axial direction in order to separate the anti-rotating portion 45b from the fixture 42.

Referring to FIG. 3 (b), the internal implant comprises a fixture 52, an internal abutment 54, a screw 56, and a prosthetic appliance 58. The fixture 52 comprises a joining groove in the upper end thereof. The abutment 54 comprises a joining projection 55 corresponding to the joining groove. The joining projection 55 is formed in the lower end of a body of the abutment 54. A bonding portion, which is bonded to prosthetic appliance 58 with dental cement, is formed in the upper end of the body.

The joining groove of the conventional fixture 52 is formed in a circular or polygonal cylindrical shape, and the joining projection 55 of the abutment 54 corresponding to that is also formed in the circular or polygonal cylindrical shape. Especially, if using the circular cylindrical joining projection, projections or grooves for limiting a relative rotation between the joining projection and the joining groove may be used.

In the structure of the internal implant shown in FIG. 3 (b), since the joining projection and the joining groove are formed in the cylindrical shape, the abutment 54 must be retracted in the axial direction in order to separate the joining projection 55 from the fixture 52. At this time, the distance to be moved along in the axial direction is too long.

### DISCLOSURE OF INVENTION

As described above, advantages and disadvantages of the screw retained prosthesis and the cement retained prosthesis are summarized as follows. The screw retained prosthesis has the advantages that the prosthetic appliance is freely mounted and separated, and the treatment can be performed even with a short intermaxillary distance. However, there are some disadvantages that it is difficult to achieve a precise passive fit, the screw often comes loose, precise clinical and laboratory procedures are required, and a high cost and a long time are required.

On the other hand, the cement retained type has the many advantages in that the passive fit can be easily achieved, the clinical and laboratory procedures are simple, and time and cost are reduced. However, since the prosthetic appliance cannot be easily separated once the prosthetic appliance and the abutment are bonded, there are some disadvantages that repairs of the prosthetic appliance are difficult, removing the remaining cement in the oral cavity is also difficult, and polishing a border cannot be performed even if the border of the prosthetic appliance is unfit.

Therefore, one object of the present invention is to provide a tertiary prosthetic method, which can adopt and reject the advantages and solve the disadvantages of both prosthetic methods, and to apply the tertiary prosthetic method to an internal implant. That is to say, it is the object to provide a prosthesis treating method and an abutment which make the clinical and manual operation procedures simple; easily provide a passive fitness with time and cost savings; make it difficult for a screw to come loose; can be applied even in a short intermaxillary distance; make it easy to repair and mend the prosthetic appliance; make it easy to remove the remaining cement of subgingival; make it possible to polish the border of the prosthetic appliance; and enable the prosthetic appliance to be separated and remounted without damage whenever required

Furthermore, another object of the present invention is to provide a treatment method for an internal implant and an abutment wherein the abutment can be easily mounted and separated even if axial lines of the internal fixtures do not accord with each other.

According to a preferred embodiment of the present invention for achieving the above described objects, in a method for treating a screw-cement retained prosthesis, an abutment, which comprises a joining projection formed on a lower portion thereof and a first screw hole formed upward and downward through thereof, is provided, and after repositioning the joining projection to a joining groove formed at an upper portion of a fixture correspondingly to the joining projection, the abutment is engaged to the fixture by using a screw corresponding to the first screw hole. Then, a prosthetic appliance including a second screw hole corresponding to the first screw hole is provided, and the prosthetic appliance and the abutment are bonded by using dental cement, so that the screw-cement retained prosthesis is treated.

The method for treating the screw-cement retained prosthesis according to the present invention relates to an internal implant wherein the joining projection of the abutment is inserted into and fixed to the fixture. The present invention has features of the cement retained prosthesis (CRP) since the prosthetic appliance and the abutment are bonded using the dental cement, and also has features of the screw retained prosthesis (SRP) since the screw can be tightened or loosened through the first and the second screw holes. That is to say, since the abutment before bonding to the prosthetic appliance is tightened to the fixture and the prosthetic appliance is bonded onto the abutment with the cement, the treatment makes a precise passive fit possible and is quickly and simply performed like a cement retained prosthesis. Furthermore, since the second screw hole is formed in the prosthetic appliance, it is possible to tighten and loosen the screw, so that even after bonding the prosthetic appliance can be easily separated from and remounted to the fixture. Therefore, even if permanent cement is used as the dental cement, there is no burden to achieve separation.

The method for treating the implant according to the present invention, which includes the advantages of the screw retained type and the cement retained type and solves the disadvantages of both the types, is referred to as a screw-cement retained prosthesis or a screw-cement retained implant, hereinafter, an SCRP implant.

Concretely, in the method for treating the SCRP implant, before the prosthetic appliance and the abutment are bonded with the dental cement, the prosthetic appliance is subjected to trial adaptation. The trial adaptation of the prosthetic appliance is the process determining whether the prosthetic appliance is fitted to the abutment, so that it is confirmed by assembling the prosthetic appliance and the abutment without dental cement.

Furthermore, before the prosthetic appliance and the abutment are bonded, the first screw hole is filled with supplementary filler such as gauze or cotton ball. As such, the supplementary filler may be used in order to prevent the first screw hole from being clogged with the dental cement such as the permanent cement, which is introduced into the first screw hole during the bonding process.

Contrary to the cement retained prosthesis (CRP), even after bonding the prosthetic appliance and abutment of the SCRP implant can be easily separated from the fixture. Since the prosthetic appliance and abutment can be separated by loosening the screw through the second screw hole, the remaining cement after the bonding process can be cleanly removed, and it is also possible to completely finish the implant treatment by polishing the border of the prosthetic appliance.

According to another preferred embodiment of the present invention for solving the above problems, a method for treating a screw-cement retained prosthesis is provided, which comprises providing an implant wherein an internal abutment including a first screw hole is engaged to a fixture and a prosthetic appliance is bonded to the abutment, forming a second screw hole in the prosthetic appliance correspondingly to the first screw hole, and separating the prosthetic appliance and abutment, which are bonded to each other, from the fixture by loosening the screw through the first and the second screw holes.

Since the second screw hole corresponding to the first screw hole is not formed when the prosthetic appliance is bonded, after the treatment, a neat appearance is provided, so that a patient can achieve maximum satisfaction. Furthermore, since the second screw hole may be formed in the prosthetic appliance by using a delicate drill, it is possible to achieve the advantages of the SCRP implant. Therefore, such an SCRP implant can provide a beautiful implant from aesthetic point of view and preferable occlusion after the first treatment. In a case where replacement or repair is needed hereafter, the prosthetic appliance and abutment can be easily separated from the fixture by simply forming the second screw hole.

The method for treating the SCRP implant may be usefully applied especially to the case that an SCRP abutment described below is employed. A mark for finding the second screw hole may be represented on the prosthetic appliance.

According to a preferred embodiment of the present invention for achieving the above described objects, an SCRP abutment according to the present invention is a cement retained abutment of a kind used in an internal fixture, and comprises a body of the abutment and a joining projection formed at a lower portion of the body.

The body of the abutment comprises a bonding portion bonded to the prosthetic appliance and a screw hole formed upward and downward through the body. Generally, shapes or configurations of the bonding portion and the screw hole are variously modified referring to those of the cement retained abutment employed in the conventional internal implant.

The joining projection of the abutment is formed integrally with the body at the lower portion of the body. The joining projection includes a sticking portion and an anti-rotating portion, and the screw hole is formed in the body through the sticking portion and the anti-rotating portion. The sticking portion and the anti-rotating portion may be formed to be separated from each other. Alternatively, the sticking portion and the anti-rotating portion may be integrally formed as the polygonal cylindrical joining projection. The sticking portion is entirely or partially stuck to the joining groove formed in an upper portion of the fixture and then supports the body of the abutment. The anti-rotating portion is formed adjacently to the sticking portion, so that the abutment is limited to rotate with respect to the fixture and is guided to be set in constant direction. Generally, though the anti-rotating portion is formed in a hexagonal or octagonal cylindrical shape, the anti-rotating portion may be alternatively formed in various shapes such as a non-circular shape where joining projections are formed on a circular cylinder, a polygonal cylinder, or a polygonal pyramid.

Especially, in the SCRP abutment according to the present invention, the joining projection comprises a leading inclined surface, which is formed by removing the sticking portion or the anti-rotating portion partially. The leading inclined surface provides an allowance space between the joining projection and the joining groove when the abutment and the fixture are engaged to each other. Due to the allowance space, the prosthetic appliance and multiple abutments, which are bonded to each other, can be easily separated from the fixtures, even if the fixtures are not parallel.

The SCRP abutment structure according to the present invention is usefully employed in the case that the plural abutments are integrally bonded to a prosthetic appliance. For example, when the plural fixtures are implanted into the alveolar bone, the plural fixtures are implanted generally slantingly at certain degrees of angles with respect to each other.

However, a bonded member of the prosthetic appliance and the abutments, which are formed by using the abutments for the conventional internal implant, does not have sufficient allowance spaces between the abutments and the fixtures to be separated from the fixtures. Therefore, when the bonded member is separated from the fixtures, each of the abutments should be separated in the axial direction thereof. However, since the axial directions of the abutments are not parallel to each other, the bonded member of the prosthetic appliance and the abutment would not be separated from the fixtures, and a patient's prosthetic structure, which is stably treated, can be damaged in a process where the bonded member is forcibly separated.

However, the SCRP prosthetic structure using the abutments according to the present invention causes the bonded member to be easily separated from the fixtures by using the allowance spaces provided by the leading inclined surfaces. That is to say, when the bonded member is separated from the fixtures, while the joining projections of the abutments free themselves from the joining grooves, the joining projections are allowed to move within the range of the allowance spaces, so that the plural joining projections are smoothly separated from the fixtures along the leading inclined surfaces. Another advantage of the SCRP abutment is that each abutment can be repositioned in the fixture by the anti-rotating portions of the abutment.

As mentioned above, fundamentally, the SCRP abutment according to the present invention has a structure similar to that of the abutment employed in a cement retained prosthesis (CRP) for the internal implant. In the present SCRP abutment, the joining projection has the feature of the leading inclined surface and the anti-rotating portion, which are formed by removing the sticking portion or the anti-rotating portion partially.

### BRIEF DESCRIPTION OF DRAWINGS

FIG. 1a is a sectional view of a conventional screw retained prosthesis using an UCLA abutment on an external hex implant.

FIG. 1b is a sectional view of a conventional screw retained prosthesis using an intermediate abutment on an external hex implant.

FIG. 2 is a sectional view of the conventional cement retained prosthesis on an external hex implant.

FIG. 3 is a sectional view for explaining a conventional internal implant.

FIG. 4 is a sectional view of an SCRP implant according to Embodiment 1 of the present invention.

FIGS. 5a to 5e are sectional views for explaining a method for treating the SCRP implant according to Embodiment 1.

FIG. 6 is a sectional view of an SCRP implant according to Embodiment 2 of the present invention.

FIG. 7 is a sectional view for explaining a separating process of the SCRP implant according to Embodiment 2.

FIG. 8 is a sectional view of an SCRP implant according to Embodiment 3 of the present invention.

FIG. 9 is a sectional view for explaining a separating process of the SCRP implant according to Embodiment 3.

FIG. 10 is a sectional view of an SCRP implant according to Embodiment 4 of the present invention.

FIG. 11 is a sectional view for explaining the separating process of the SCRP implant according to Embodiment 4.

FIG. 12 is a sectional view of an SCRP implant according to Embodiment 5 of the present invention.

FIG. 13 is a sectional view for explaining a separating process of the SCRP implant according to Embodiment 5.

FIG. 14 is a sectional view of an SCRP implant according to Embodiment 6 of the present invention.

FIG. 15 is a top view of a fixture in the SCRP implant according to Embodiment 6.

FIG. 16 is a sectional view of an SCRP abutment according to an embodiment similar to, but different from, Embodiment 6.

FIG. 17 is a top view of a fixture.

FIG. 18 is an exploded perspective view for explaining a SCRP implant according to Embodiment 7 of the present invention and an abutment used therein.

FIG. 19 is a sectional view for explaining a separating process of the SCRP implant according to Embodiment 7.

FIG. 20 is an exploded perspective view for explaining a SCRP implant according to Embodiment 8 of the present invention and an abutment used therein.

FIG. 21 is an exploded perspective view for explaining an SCRP implant according to an embodiment similar to, but different from, Embodiment 8 and an abutment used therein

FIG. 22a is a sectional view of an SCRP implant according to Embodiment 9 of the present invention.

FIG. 22b is a sectional view for explaining a separating process of the SCRP implant according to Embodiment 9.

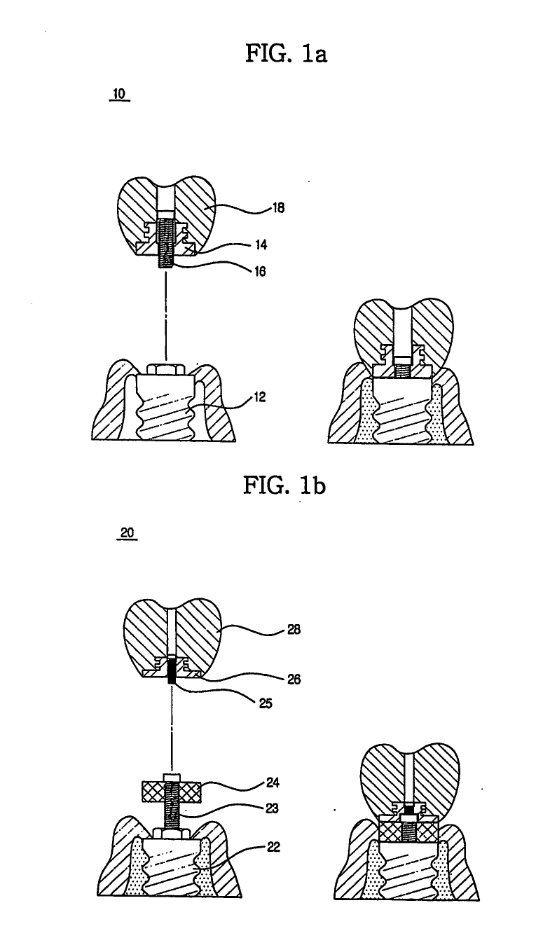

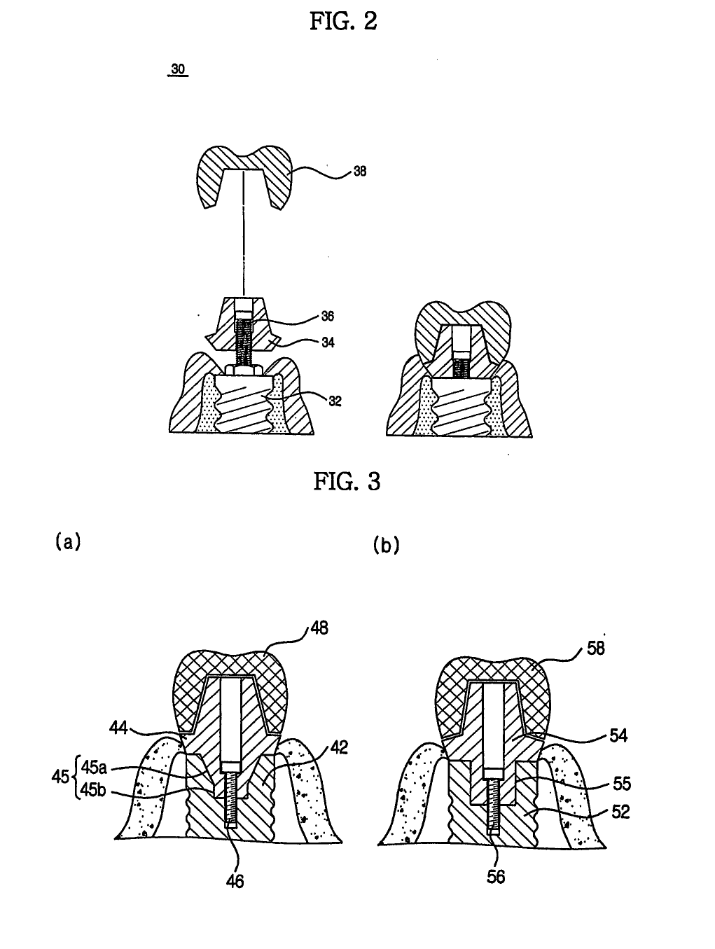

### BEST MODE FOR CARRYING OUT THE INVENTION

Though the embodiments of the present invention will be described as below referring to the accompanying drawings, the present invention is not limited or restricted by the below embodiments.

### EMBODIMENT 1

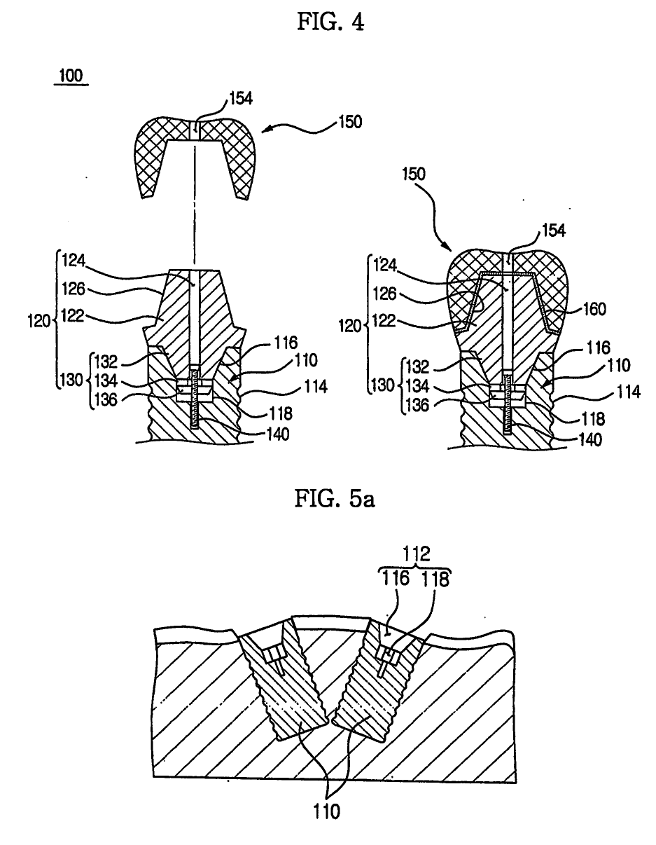

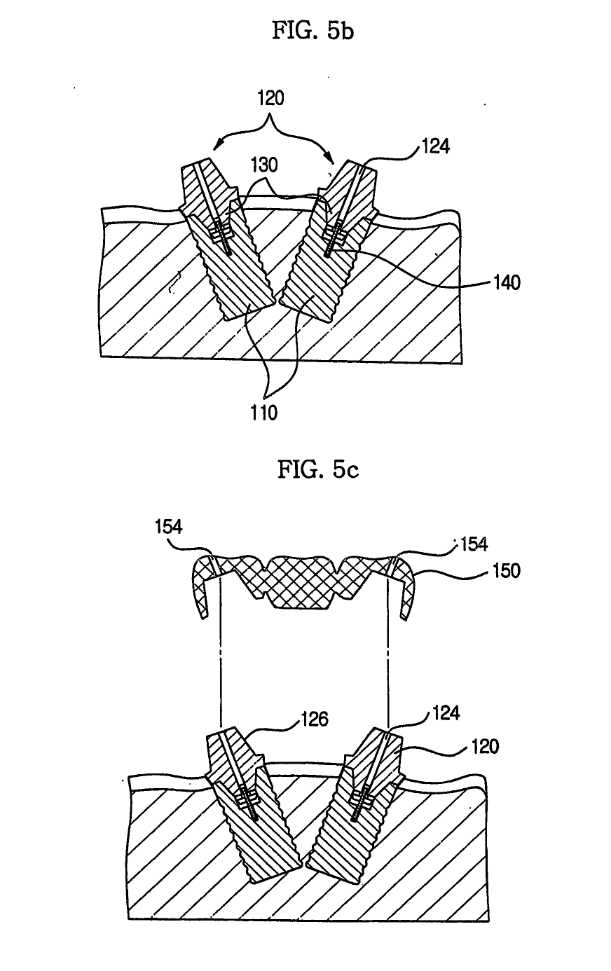

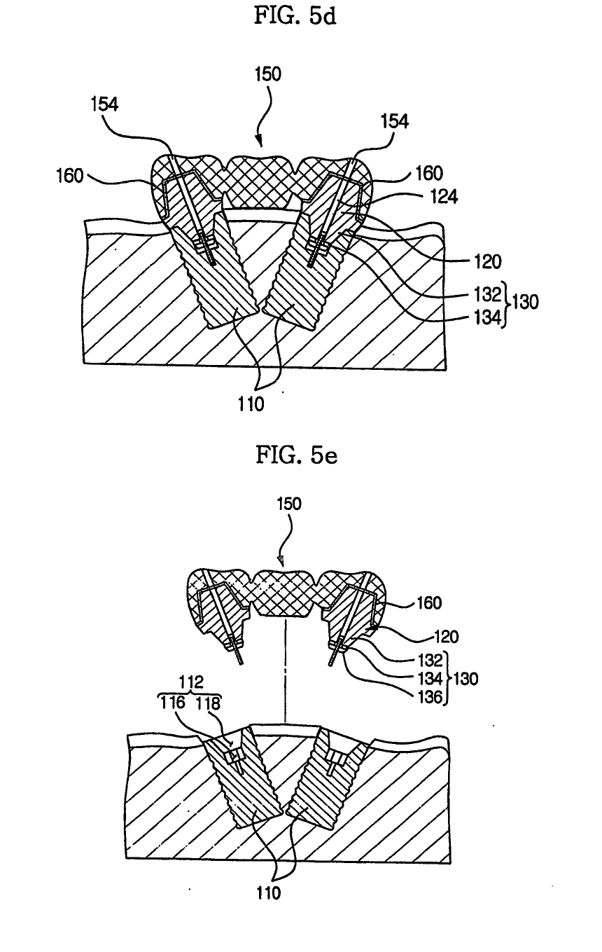

FIG. 4 is a sectional view of an SCRP implant according to Embodiment 1 of the present invention, and FIGS. 5a to 5e are sectional views for explaining a method for treating the SCRP implant according to Embodiment 1.

Referring to FIG. 4, the SCRP implant 100 according to Embodiment 1 comprises a fixture 110, an abutment 120, a screw 140 and a prosthetic appliance 150.

The fixture 110 comprises the thread 114 formed in its outer surface and is implanted along the thread 114 to the alveolar bone. The thread 114 of the implanted fixture 110 is fused with tissue of the alveolar bone and then is fixed to the alveolar bone. Generally, considerable time is needed for bonding the thread 114 and the alveolar bone to each other.

A joining groove 112 for receiving a joining projection 130 of the abutment 120 is formed on an upper surface of the fixture 110. The joining groove 112 has a circular inlet, and comprises a sticking groove 116 in a truncated circular conical shape overturned from the inlet, that is a trumpet shape. An anti-rotating groove 118, which has a predetermined depth, is formed in a hexagonal or octagonal cylindrical shape at a lower end of the sticking groove 116. A female screw hole corresponding to the screw 140 is formed at the center of a lower end of the anti-rotating groove 118.

The abutment 120 according to Embodiment 1 comprises a body 122 and the joining projection 130, wherein a first screw hole 124 is formed through the body 122 and the joining projection 130.

A bonding portion 126 is formed in an outer surface of an upper portion of the body 122. Though an outer surface of the bonding portion 126 and an inner surface of a framework of a prosthetic appliance 150 are formed in shapes corresponding to each other, contrary to the screw retained prosthesis (SRP), the outer surface of the bonding portion 126 and the inner surface of the prosthetic appliance 150 do not accurately accord with each other. That is to say, in the implant according to the present embodiment, there is a space between the abutment 120 and the prosthetic appliance 150 for allowing a relative motion thereof, so that the passive fit can be achieved. Even when the shapes between the abutment 120 and the prosthetic appliance 150 do not accord with each other exactly, the abutment 120 and the prosthetic appliance 150 are firmly secured by dental cement 160 interposed therebetween. In addition, the structure of the body, the configuration of the bonding portion, or the like may be designed by referring to cement retained abutments of the conventional internal implants or used by selecting some of them.

The abutment 120 comprises the joining projection 130 formed at a lower portion of the body 122 correspondingly to the joining groove 112 of the fixture 110. The joining projection 130 comprises a sticking portion 132 and an anti-rotating portion 134 corresponding to the sticking groove 116 and the anti-rotating groove 118 of the joining groove 112, respectively. The sticking portion 126 is formed at the lower portion of the body 122 in a truncated circular conical shape correspondingly to the sticking groove 116. Hence, the anti-rotating portion 134 is extended from a lower end of the sticking portion 132 and formed in a hexagonal cylindrical shape correspondingly to the anti-rotating groove 118 of the joining groove 112. While the joining projection 130 of the abutment 120 is inserted into the joining groove 112, the sticking portion 132 comes into contact with the sticking groove 116 entirely or partially, and then supports the abutment 120. Due to the anti-rotating groove 118, the anti-rotating portion 134 constantly holds the direction, in which the abutment 120 is fixed, and assists the abutment 120 to be always repositioned.

As shown in FIG. 4, a leading inclined surface 136, which is tapered by partially removing the lower portion, is formed at the lower portion of the anti-rotating portion 134. The anti-rotating portion 134 for holding the direction, in which the abutment 120 is fixed, remains in the hexagonal cylindrical shape on an upper portion of the leading inclined surface 136. Even if the anti-rotating portion 134 is formed with a height generally within a range of about 1 mm, preferably about 0.3˜0.4 mm, the anti-rotating portion 134 can sufficiently prevent rotation.

The first screw hole 124 is formed on the center of the abutment 120. The screw 140 is tightened to a female screw hole of the fixture 110 through the first screw hole 124, so that the abutment 120 and the fixture 110 are engaged to each other.

Furthermore, contrary to the conventional cement retained prosthesis, the prosthetic appliance 150 of the SCRP implant 100 comprises a second screw hole 154. The prosthetic appliance 150 is fabricated of a two-layered structure of a metal framework and a porcelain or only metal structure and is formed with the second screw hole 154 corresponding to the first screw hole 124. The second screw hole 154 is not used to initially fix the abutment 120 to the fixture 110, but used to separate or remount the bonded abutment 120 and prosthetic appliance 150 from or to the fixture 110.

The method for treating the SCRP implant 100 will be explained below referring to the accompanying drawings.

Referring to FIG. 5a, the two fixtures 110 are implanted into the alveolar bone, unparallel to each other, and slantingly at certain angles. Therefore, the joining grooves 112 formed on the upper ends of the fixtures 110 also face in different directions from each other. Furthermore, the joining grooves 112 comprise the truncated circular conical sticking grooves 116 and the hexagonal cylindrical anti-rotating grooves 118.

Referring to FIG. 5b, the abutments 120 for the SCRP implant are fixed to the two fixtures 110, respectively. The joining projections 130 of the abutments 120 are inserted into the joining grooves 112 of the fixtures 110, and the screws 140 are engaged to the fixtures 110 through the first screw holes 124, so that the abutments 120 are fixed to the fixtures 110.

Referring to FIG. 5c, the prosthetic appliance 150 is provided which is fabricated correspondingly to a patient's dentition. The prosthetic appliance 150 is formed by casting a framework according to a general method, and the second screw holes 154 are formed along with the framework. In order to prevent breakage of the material, a metal chimney may be formed up to the occlusal surface. However, according to the circumstances, the metal cannot be also used around the second screw holes 154 (which is referred to as a metal free hole) from an aesthetic point of view. The framework of the prosthetic appliance 150 is adjusted for the passive fit correspondingly to the abutments 120 and is formed with inner surfaces, each of which is corresponding to each of the abutments.

Referring to FIG. 5d, the prosthetic appliance 150 and the abutments 120 are bonded by interposing the permanent cement 160 between the prosthetic appliance 150 and the abutments 120.

Before bonding the abutments 120 to the prosthetic appliance 150, the prosthetic appliance 150 may be subjected to trial adaptation. When the prosthetic appliance 150 has been subjected to the trial adaptation, the abutments 120 may be repositioned to the fixtures 110 one by one without the prosthetic appliance 150. At this time, using the anti-rotating portions 134 of the joining projections 130, the abutments 120 may be connected at correct positions and angles. If there is not the anti-rotating portion, the abutments can be connected at incorrect angles due to a rotation, so that the already fabricated prosthetic appliance 150 may become unfit. When the prosthetic appliance 150 has been subjected to the trial adaptation, tightening and loosening of the screws 140 is adjusted through the second screw holes 154. Configurations of the abutments 120 may be adjusted until the prosthetic appliance 150 rests in the abutments 120 without any resistance and the border fits completely.

After adjusting the fitness between the abutments 120 and the prosthetic appliance 150 by the trial adaptation of the prosthetic appliance 150, the first screw holes 124 of the abutments 120 are filled with gauze or cotton. The use of supplementary filler such as gauze or cotton is done so that the first screw holes 124 are prevented from being clogged with the cement introduced into the first screw holes 124 during bonding the abutments 120.

Then, after interposing the permanent cement 160 between the abutments 120 and the prosthetic appliance 150, the abutments 120 and the prosthetic appliance 150 are bonded. Resin luting cement and the like may be used as the permanent cement 160. After a lapse of a period of certain time, the permanent cement 160 hardens, so that the abutments 120 and the prosthetic appliance 150 are firmly bonded.

Referring to FIG. 5e, after the abutments 120 and the prosthetic appliance 150 are bonded, the supplementary filler with which the first screw holes 124 are filled is removed. Then, the abutments 120 and prosthetic appliance 150 may be separated from the fixtures 110 by loosening all of the screws 140 through the first and the second screw holes 124, 154. At this time, the abutments 120 constitute an implant portion by bonding them to the prosthetic appliance 150.

Contrary to the conventional cement retained prosthesis (CRP), even after bonding the abutments 120 and the prosthetic appliance 150, the bonded member can be easily separated from the internal fixture. That is the reason why all of the screws 130 can be removed through the second screw holes 154 and structurally allowance spaces in the improved abutments 120 are provided.

Again, compared with the abutments shown in FIGS. 3 and 4, the joining projection 130 of the abutment 120 according to the present embodiment comprises the short anti-rotating portion 134 and the leading inclined surface 136. Therefore, as shown in FIG. 5e, the allowance spaces are formed between the joining projections 130 and the joining grooves 112. Even if the joining projections 130 move a little, the joining projections 130 can free themselves from the joining grooves 112. The joining projections 130 can move along inner surfaces of the sticking grooves 116 without interference due to the leading inclined surfaces 136. However, if the treatment is performed using the abutments shown in FIG. 3 under the same condition as that in FIG. 5e, the prosthetic portion formed integrally with the abutments cannot be separated from the fixtures since the abutments can be separated only if they move in different directions from each other.

Again referring to FIG. 5e, after separating the prosthetic portion, which is constituted by the abutments 120 and the prosthetic appliance 150, the remaining cement around the gingiva and the abutments 120 can be removed and the fit can be precisely adjusted by polishing the border of the prosthetic appliance 150.

In final brief, the method for treating the SCRP implant is completed by inserting the prosthetic portion into the oral cavity, fixing the prosthetic portion to the fixture 110 with the screw 140, and closing the second screw hole 154 by filling it with plastic or ceramic material.

### EMBODIMENT 2

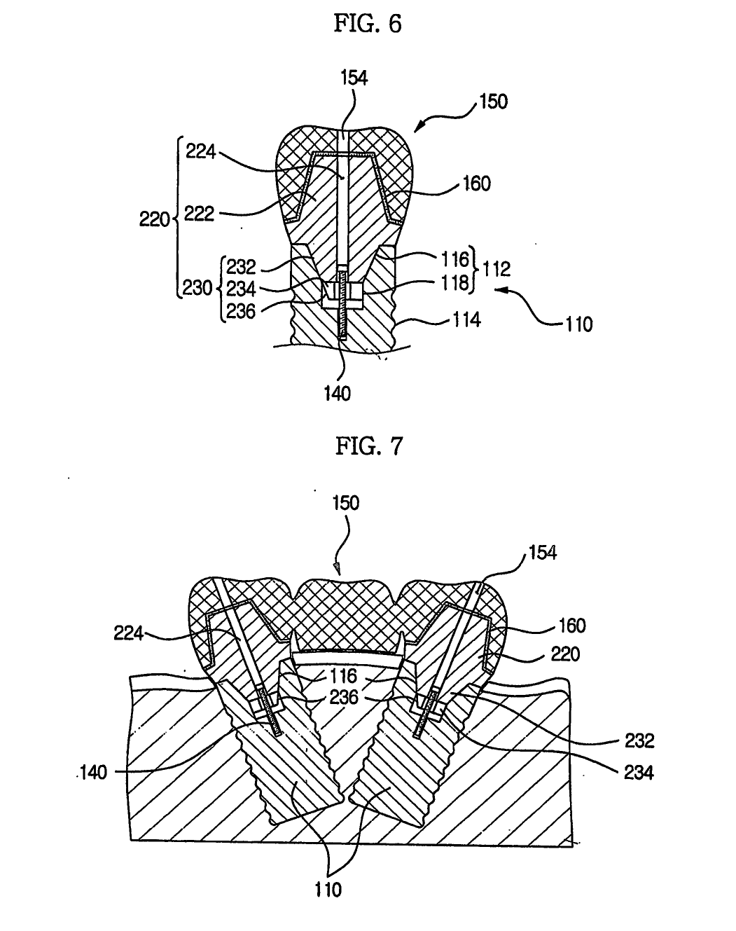

FIG. 6 is a sectional view of an SCRP implant according to Embodiment 2 of the present invention, and FIG. 7 is a sectional view for explaining a separating process of the SCRP implant according to Embodiment 2.

Referring to FIG. 6, the SCRP implant according to Embodiment 2 comprises the fixture 110, an abutment 220, the screw 140 and the prosthetic appliance 150. The fixture 110, screw 140 and prosthetic appliance 150 except the abutment 220 may refer to the explanations and drawings of Embodiment 1, and repetitional contents may be omitted.

The fixture 110 comprises the joining groove 112 and the thread 114, wherein the joining groove 112 comprises the truncated circular conical sticking groove 116 and the anti-rotating groove 118. A female screw hole corresponding to the screw 140 is formed at the center of the lower end of the anti-rotating groove 118.

In the same manner as Embodiment 1, the abutment 220 according to the present embodiment comprises a body 222 and a joining projection 230. The first screw hole 224 is formed through the body 222 and the joining projection 230. A bonding portion 226 is formed at the outer surface of the upper portion of the body 222.

The abutment 220 comprises a joining projection 230 formed at the lower portion of the body 222 correspondingly to the joining groove 112 of the fixture 110. The joining projection 230 comprises a sticking portion 232 and an anti-rotating portion 234. The sticking portion 226 is formed at the lower portion of the body 222 in a truncated circular conical shape correspondingly to the sticking groove 116. Hence, the anti-rotating portion 234 is extended from the lower end of the sticking portion 232 and formed in a hexagonal cylindrical shape correspondingly to the anti-rotating groove 118. When the joining projection 230 of the abutment 220 is inserted into the joining groove 112, the sticking portion 232 comes into contact with the sticking groove 116 partially or entirely, and then supports the abutment 220. Due to the anti-rotating groove 118, the anti-rotating portion 234 constantly holds the direction, in which the abutment 220 is fixed, and assists the abutment 220 to be always repositioned.

As shown in FIG. 6, a leading inclined surface 236 according to the present embodiment is different from the leading inclined surface 136 of Embodiment 1. While the leading inclined surface 136 of Embodiment 1 is formed through 360 degrees at the lower end of the anti-rotating portion 134, the leading inclined surface 236 of the present embodiment is formed with a half portion of the anti-rotating portion 234 partially removed, being the tapered leading inclined surface 236. Therefore, a portion of the hexagonal cylindrical shape corresponding to 180 degrees of the anti-rotating portion 234 remains, so that such an anti-rotating portion 234 constantly and sufficiently holds the direction in which the abutment 120 is fixed. At this time, the leading inclined surface 236 is preferably formed at an angle equal to or more than the angle of the circular conical portion of the sticking portion 232, and the height of the anti-rotating portion 234 is not limited to within the height of the anti-rotating groove 118.

The first screw hole 224 is formed at the center of the abutment 220. The screw 140 is tightened to the female screw hole of the fixture 110 through the first screw hole 224, so that the abutment 120 and the fixture 110 are engaged to each other.

Referring to FIG. 7, the two fixtures 110 are implanted into the alveolar bone unparallel and slantingly with respect to each other, and the respective abutments 220 for the SCRP implant are fixed to the two fixtures 110. The prosthetic appliance 150 and the abutments 220 are bonded by interposing the permanent cement 160 between the prosthetic appliance 150 and the abutments 220.

Then, all the screws 140 can be loosened through the first and the second screw holes 224, 154. By loosening the screws 140, the abutments 220 and prosthetic appliance 150 can be separated from the fixtures 110. At this time, the abutments 220 are bonded to the prosthetic appliance 150, forming a prosthetic portion as one body.

In the prosthetic portion according to the present embodiment, the two abutments 220 are disposed so that the leading inclined surfaces 236 face to each other. Therefore, the allowance spaces are formed between the joining projections 230 and the joining grooves 112. Due to the leading inclined surfaces 236, the joining projections 230 free themselves from the joining grooves 112 without interference.

In the same manner as Embodiment 1, after separating the prosthetic portion, which is constituted by the abutment 220 and the prosthetic appliance 150, the remaining cement around the gingiva and the abutment 220 can be removed and the fit can be precisely adjusted by polishing the border of the prosthetic appliance 150.

### EMBODIMENT 3

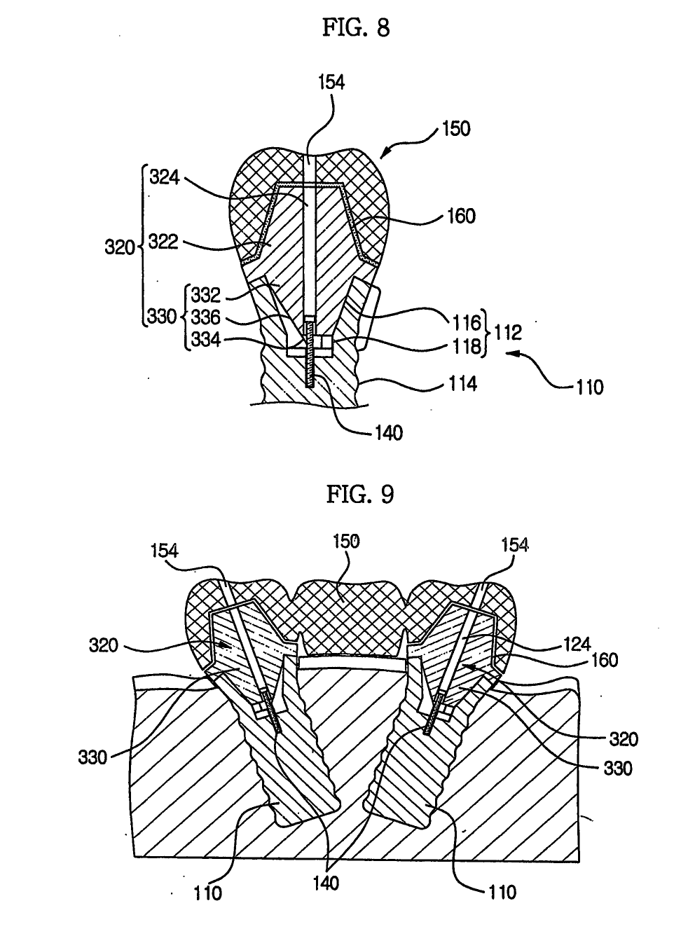

FIG. 8 is a sectional view of an SCRP implant according to Embodiment 3 of the present invention, and FIG. 9 is a sectional view for explaining a separating process of the SCRP implant according to Embodiment 3.

Referring to FIG. 8, the SCRP implant according to Embodiment 3 comprises the fixture 110, an abutment 320, the screw 140 and the prosthetic appliance 150. The fixture 110, screw 140 and prosthetic appliance 150 except the abutment 320 may refer to the explanations and drawings of Embodiment 1, and repetitional contents may be omitted.

The fixture 110 comprises the joining groove 112 and the thread 114, wherein the joining groove 112 comprises the truncated circular conical sticking groove 116 and the anti-rotating groove 118. A female screw hole corresponding to the screw 140 is formed at the center of the lower end of the anti-rotating groove 118.

In the same manner as Embodiment 1, the abutment 320 according to the present embodiment comprises a body 322 and a joining projection 330. The first screw hole 324 is formed through the body 322 and the joining projection 330. A bonding portion 326 is formed at the outer surface of the upper portion of the body 322.

The abutment 320 comprises a joining projection 330 formed at the lower portion of the body 322 correspondingly to the joining groove 112 of the fixture 110. The joining projection 330 comprises a sticking portion 332 and an anti-rotating portion 334. The sticking portion 326 is formed at the lower portion of the body 322 in a truncated circular conical shape correspondingly to the sticking groove 116. Hence, the anti-rotating portion 334 is extended from the lower end of the sticking portion 332 and formed in a hexagonal or octagonal cylindrical shape correspondingly to the anti-rotating groove 118. While the joining projection 330 of the abutment 320 is inserted into the joining groove 112, the sticking portion 332 comes into contact with the sticking groove 116 partially or entirely, and then supports the abutment 320. Due to the anti-rotating groove 118, the anti-rotating portion 334 constantly holds the direction, in which the abutment 320 is fixed, and assists the abutment 320 to be always repositioned.

As shown in FIG. 8, a leading inclined surface 336 according to the present embodiment is different from the leading inclined surface 236 of Embodiment 1. While the leading inclined surface 236 of Embodiment 2 is formed with only half of the anti-rotating portion 134 removed, the leading inclined surface 336 of the present embodiment is formed with half portions of both of the sticking portion 332 and the anti-rotating portion 334 partially removed, being the tapered leading inclined surface 336. Only, in order for the sticking portion 332 to support the abutment 320 stably, at least portion of an upper end of the sticking portion 332 should be maintained in an intact truncated circular conical shape. At this time, although a length of the portion in contact with the inner surface of the sticking groove 116 is different according to the angle of the circular cone, it is preferable to maintain the length of about 1˜3 mm.

The first screw hole 324 is formed on the center of the abutment 320. The screw 140 is tightened to the female screw hole of the fixture 110 through the first screw hole 324, so that the abutment 120 and the fixture 110 are engaged to each other.

Referring to FIG. 9, the two fixtures 110 are implanted into the alveolar bone unparallel and slantingly with respect to each other, and the respective abutments 320 for the SCRP implant are fixed to the two fixtures 110. The prosthetic appliance 150 and the abutments 320 are bonded by interposing the permanent cement 160 between the prosthetic appliance 150 and the abutments 320.

Then, all the screws 140 can be loosened through the first and the second screw holes 324, 154. By loosening the screws 140, the abutments 320 and prosthetic appliance 150 can be separated from the fixtures 110. At this time, the abutments 320 are bonded to the prosthetic appliance 150, forming a prosthetic portion as one body.

In the same manner as Embodiment 2, in the present embodiment, the two abutments 320 also are disposed so that the leading inclined surfaces 336 face to each other. Therefore, the allowance spaces are formed between the joining projections 330 and the joining grooves 112. Due to the leading inclined surfaces 336, the joining projections 330 free themselves from the joining grooves 112 without interference.

In the same manner as the previous embodiments, after separating the prosthetic portion, which is constituted by the abutments 320 and the prosthetic appliance 150, the remaining cement around the gingiva and the abutments 320 can be removed and the fit can be precisely adjusted by polishing the border of the prosthetic appliance 150.

### EMBODIMENT 4

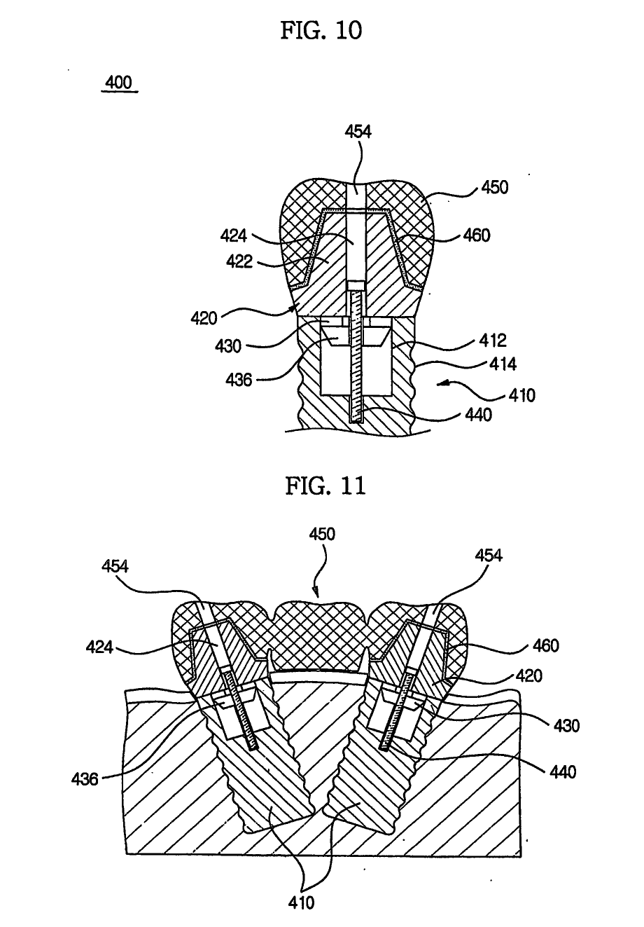

FIG. 10 is a sectional view of an SCRP implant according to Embodiment 4 of the present invention, and FIG. 11 is a sectional view for explaining the separating process of the SCRP implant according to Embodiment 4.

Referring to FIG. 10, the SCRP implant 400 according to Embodiment 4 comprises a fixture 410, an abutment 420, a screw 440 and a prosthetic appliance 450.

The fixture 410 comprises the thread 414 formed in its outer surface and is implanted along the thread 414 to the alveolar bone. A joining groove 412 for receiving a joining projection 430 of the abutment 420 is formed on an upper surface of the fixture 410. The joining groove 412 has an inlet with a polygonal cylindrical shape such as a hexagonal or octagonal cylindrical shape, and is formed in a cylindrical shape, the cross-section of which is equal to that of the inlet. A female screw hole corresponding to the screw 440 is formed at the center of the lower end of the joining groove 412.

The abutment 420 according to Embodiment 4 comprises a body 422 and the joining projection 430, wherein a first screw hole 424 is formed through the body 422 and the joining projection 430.

A bonding portion 426 is formed in the outer surface of the upper portion of the body 422. Though the outer surface of the bonding portion 426 and the inner surface of the framework of a prosthetic appliance 450 are formed in shapes corresponding to each other, contrary to the screw retained prosthesis (SRP), the outer surface of the bonding portion 426 and the inner surface of the prosthetic appliance 450 do not accurately accord with each other. There is a space between the abutment 420 and the prosthetic appliance 450 for allowing relative motion thereof, so that the passive fit can be achieved. Even when the shapes between the abutment 420 and the prosthetic appliance 450 do not accord with each other exactly, the abutment 420 and the prosthetic appliance 450 are firmly secured by dental cement 460 interposed therebetween. In addition, the structure of the body, the configuration of the bonding portion, or the like may be designed by referring to cement retained abutments of the conventional internal implants or used by selecting some of them.

The abutment 420 comprises the joining projection 430 formed at the lower portion of the body 422 correspondingly to the joining groove 412 of the fixture 410. The joining projection 430 is formed in a polygonal cylindrical shape correspondingly to the joining groove 412. Since the joining projection 430 according to the present embodiment includes a sticking portion and anti-rotating portion integrally without division therebetween, the joining projection 430 is stuck to the inner surface of the joining groove 412, and then is limited to rotate with respect to the joining groove 412. Thus, the joining projection 430 constantly holds the direction, in which the abutment 420 is fixed, and assists the abutment 420 to be always repositioned.

The lower end of the joining projection 430 is partially removed, so that a tapered leading inclined surface 436 is formed slantingly in a circular conical shape. An angled portion, which remains in a polygonal cylindrical shape at the upper portion of the leading inclined surface 436, constantly holds the direction in which the abutment 420 is fixed. Even if the height of the remaining angled portion is about 0.3˜0.5 mm, rotation can be sufficiently prevented.

The first screw hole 424 is formed on the center of the abutment 420. The screw 440 is tightened to the female screw hole of the fixture 410 through the first screw hole 424, so that the abutment 420 and the fixture 410 are engaged to each other.

Furthermore, the prosthetic appliance 450 of the SCRP implant 400 comprises a second screw hole 454. The prosthetic appliance 450 is fabricated of a two-layered structure of a metal framework and a porcelain or only metal structure and is formed with the second screw hole 454 corresponding to the first screw hole 424. The second screw hole 454 is not used to fix the abutment 420 to the fixture 410 initially, but used to separate or remount the bonded abutment 420 and prosthetic appliance 450 from or to the fixture 410.

Referring to FIG. 11, the two fixtures 410 are implanted into the alveolar bone, unparallel to each other, and slantingly at certain angles. Each of the abutments 420 for the SCRP implant is fixed to each of the two fixtures 410. The joining projections 430 of the abutments 420 are inserted into the joining grooves 412 of the fixtures 410, and the screws 440 are engaged to the fixtures 110 through the first screw holes 424, so that the abutments 420 are fixed to the fixtures 410. After the abutments 420 are fixed, the prosthetic appliance 450 including the second screw holes 454 is bonded to the abutments 420.

After the abutments 420 and the prosthetic appliance 450 are bonded, the abutments 420 and prosthetic appliance 450 may be separated from the fixtures 410 by loosening all of the screws 440 through the first and the second screw holes 424, 454.

Contrary to the conventional cement retained prosthesis (CRP), even after bonding the abutments 420 and the prosthetic appliance 450, the bonded member can be easily separated. That is the reason why all of the screws 430 can be removed through the second screw holes 454 and structural allowance spaces in the improved abutments 420 are provided.

Again, compared with the abutments shown in FIG. 5(a), the abutment 420 according to the present embodiment comprises the short joining projection 430, and the leading inclined surface 436 is formed at the end of the joining projection 430. Therefore, as shown in FIG. 11, the allowance spaces are formed between the joining projections 430 and the joining grooves 412. Even if the joining projections 430 move a little, the joining projections 430 can free themselves from the joining grooves 412. The joining projections 430 can move without interference due to the leading inclined surfaces 436.

Again referring to FIG. 10, after separating the prosthetic portion, which is constituted by the abutments 420 and the prosthetic appliance 450, the remaining cement around the gingiva and the abutments 420 can be removed and the fit can be precisely adjusted by polishing the border of the prosthetic appliance 450. In final brief, the method for treating the SCRP implant is completed by inserting the prosthetic portion into the oral cavity, fixing the prosthetic portion to the fixture 410 with the screw 440, and closing the second screw hole 454 by filling it with plastics or ceramic material.

### EMBODIMENT 5

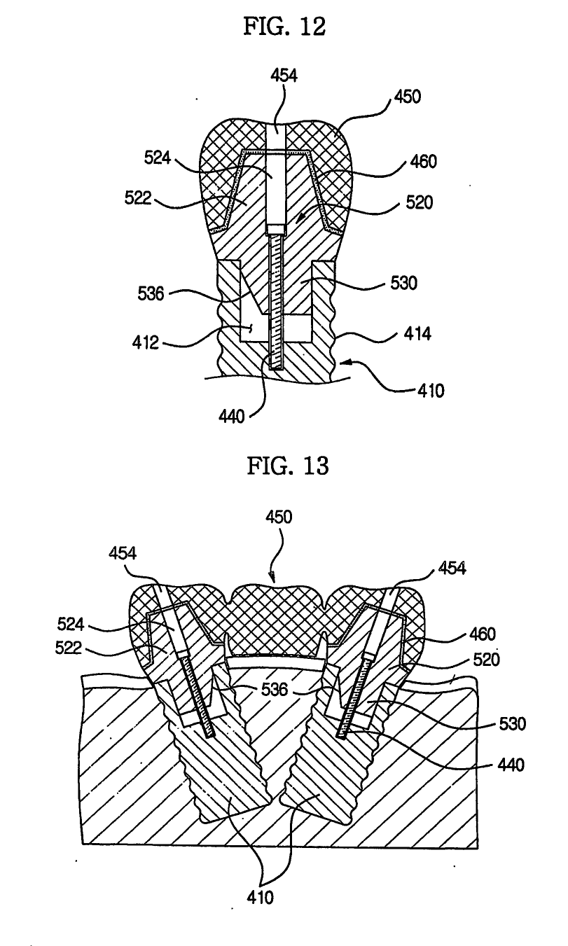

FIG. 12 is a sectional view of an SCRP implant according to Embodiment 5 of the present invention, and FIG. 13 is a sectional view for explaining a separating process of the SCRP implant according to Embodiment 5.

Referring to FIG. 12, the SCRP implant according to Embodiment 5 comprises the fixture 410, an abutment 520, the screw 440 and the prosthetic appliance 450. The fixture 410, screw 440 and prosthetic appliance 450 except the abutment 520 may refer to the explanations and drawings of Embodiment 4, and repetitional contents may be omitted. The fixture 410 comprises the thread 414 formed in its outer surface, and a joining groove 412 for receiving a joining projection 530 of the abutment 520 is formed in the upper surface of the fixture 410. The joining groove 412 according to the present embodiment has an inlet with a polygonal cylindrical shape such as a hexagonal or octagonal cylindrical shape, and is formed in the cylindrical shape, the cross-section of which is equal to that of the inlet. However, according to another embodiment of the present invention, the joining groove may be formed in a circular cylindrical shape, wherein the joining projection and the joining groove are formed with projections and grooves corresponding to each other, which prevent a relative rotation therebetween. A female screw hole corresponding to the screw 440 is formed at the center of the lower end of the joining groove 412.

The abutment 520 according to Embodiment 5 comprises a body 522 and the joining projection 530, wherein a first screw hole 524 is formed through the body 522 and the joining projection 530.

A bonding portion is formed in the outer surface of the upper portion of the body 522. Though the outer surface of the bonding portion and the inner surface of the framework of a prosthetic appliance 450 are formed in shapes corresponding to each other, contrary to the screw retained prosthesis (SRP), the outer surface of the bonding portion and the inner surface of the prosthetic appliance 450 do not accurately accord with each other. There is a space between the abutment 520 and the prosthetic appliance 450 for allowing relative motion thereof, so that the passive fit can be achieved. Even when the shapes between the abutment 520 and the prosthetic appliance 450 do not accord with each other exactly, they are firmly secured by dental cement 460 interposed therebetween.

The abutment 520 includes the joining projection 530 formed at the lower portion of the body 522 correspondingly to the joining groove 412 of the fixture 410. The joining projection 530 is formed in a polygonal cylindrical shape correspondingly to the joining groove 412. Since the joining projection 530 according to the present embodiment includes a sticking portion and anti-rotating portion integrally without division therebetween, the joining projection 530 is stuck to the inner surface of the joining groove 412, and then is limited to rotate with respect to the joining groove 412. Thus, the joining projection 530 constantly holds the direction, in which the abutment 520 is fixed, and assists the abutment 520 to be always repositioned.

As shown in FIG. 12, a leading inclined surface 536 according to the present embodiment is different from the leading inclined surface 436 of Embodiment 4. While the leading inclined surface 436 of Embodiment 4 is formed through 360 degrees at the lower end of the anti-rotating portion 434, the leading inclined surface 536 of the present embodiment is formed with a half portion of the joining projection 530 partially removed, being the tapered leading inclined surface 536. Therefore, a portion of hexagonal cylindrical shape corresponding to 180 degrees of the joining projection 530 remains, so that such the joining projection 530 constantly and sufficiently holds the direction in which the abutment 520 is fixed. Only, in order for the joining projection 530 to support the abutment 520 stably, at least a portion of the upper end of the joining projection 530 should be maintained in an intact polygonal cylindrical shape. At this time; although a length of the portion in complete contact with the inner surface of the joining groove 412 at the joining projection 530 may vary according to an angle of the leading inclined surface 536, it is preferable to maintain the length to be thin, generally between about 0.3˜0.5 mm.

The first screw hole 524 is formed on the center of the abutment 520. The screw 440 is tightened to the female screw hole of the fixture 410 through the first screw hole 524, so that the abutment 520 and the fixture 410 are engaged to each other.

Furthermore, the prosthetic appliance 450 of the SCRP implant 400 comprises a second screw hole 454. The prosthetic appliance 450 is fabricated of a two-layered structure of a metal framework and a porcelain or only metal structure and is formed with the second screw hole 454 corresponding to the first screw hole 524. The second screw hole 454 is not used to initially fix the abutment 520 to the fixture 410, but to separate or remount to the bonded abutment 520 and prosthetic appliance 450 from or to the fixture 410.

Referring to FIG. 13, the two fixtures 410 are implanted into the alveolar bone slantingly with respect to each other. Each of the abutments 520 for the SCRP implant is fixed to each of the two fixtures 410. The joining projections 530 of the abutments 520 are inserted into the joining grooves 412 of the fixtures 410, and the screws 440 are engaged to the fixtures 410 through the first screw holes 524, so that the abutments 520 are fixed to the fixtures 410. After the abutments 520 are fixed, the prosthetic appliance 450 including the second screw holes 454 is bonded to the abutments 520.

After the abutments 520 and the prosthetic appliance 450 are bonded, the abutments 520 and prosthetic appliance 450 may be separated from the fixtures 410 by loosening all of the screws 440 through the first and the second screw holes 524, 454.

Contrary to the conventional cement retained prosthesis (CRP), even after bonding the abutments 520 and the prosthetic appliance 450, the implant can be easily separated. That is the reason why all of the screws 440 can be removed through the second screw holes 454 and structural allowance spaces in the improved abutments 520 are provided.

The abutment 520 according to the present embodiment comprises the leading inclined surface 536, which is slantingly formed with the joining projection 530 partially removed. Therefore, as shown in FIG. 13, the allowance spaces are formed between the joining projections 530 and the joining grooves 412. Even if the joining projections 530 move a little, the joining projections 530 can free themselves from the joining grooves 412. The joining projections 430 can move without interference due to the leading inclined surfaces 536.

### EMBODIMENT 6

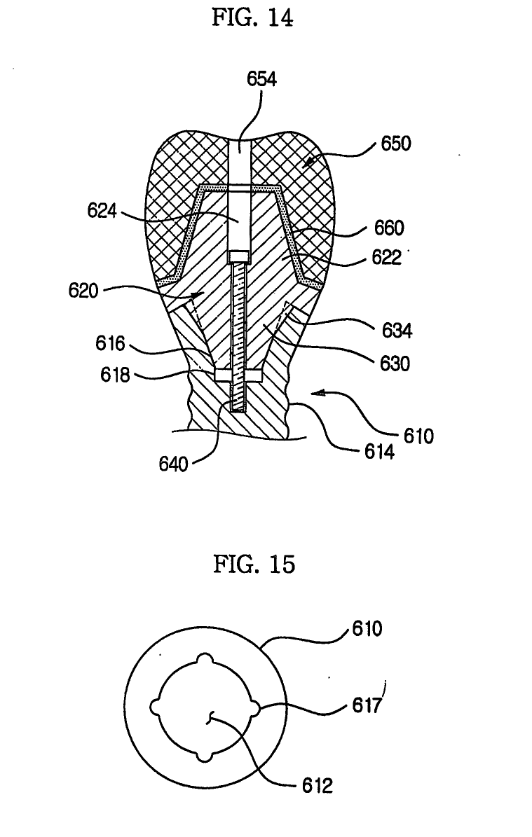

FIG. 14 is a sectional view of an SCRP implant according to Embodiment 6 of the present invention, and FIG. 15 is a top view of a fixture in the SCRP implant according to Embodiment 6.

Referring to FIGS. 14 and 15, the SCRP implant 600 according to Embodiment 6 comprises a fixture 610, an abutment 620, a screw 640 and a prosthetic appliance 650.

The fixture 610 comprises the thread 614 formed in its outer surface and is implanted along the thread 614 to the alveolar bone. After the lapse of a considerable time, the thread 614 of the implanted fixture 610 is fused with tissue of the alveolar bone and then is fixed to the alveolar bone. A joining groove 612 for receiving a joining projection 630 of the abutment 620 is formed on the upper surface of the fixture 610.

The joining groove 612 has a circular inlet, and comprises a sticking groove 616 in a truncated circular conical shape overturned from the inlet, that is a trumpet shape. An anti-rotating groove 618, which has a predetermined depth, is formed at the lower end of the sticking groove 116. A female screw hole corresponding to the screw 640 is formed at the center of the lower end of the anti-rotating groove 618.

The abutment 620 comprises a body 622 and the joining projection 630, wherein a first screw hole 624 is formed through the body 622 and the joining projection 630. A bonding portion 626 is formed in the outer surface of the upper portion of the body 622. The abutment 620 and the prosthetic appliance 650 are bonded by using dental cement 660, which is interposed between the outer surface of the bonding portion 626 and the inner surface of the framework of the prosthetic appliance 650. A lower portion of the body 622 is integrally formed with the joining projection 630 correspondingly to joining groove 612.

The joining projection 630 comprises a sticking portion 632 corresponding to the sticking groove 616 of joining groove 612 and an anti-rotating protrusion 634 formed in the outer surface of the sticking groove 616. A groove 617 is formed in the inner surface of the sticking groove 616 correspondingly to the anti-rotating protrusion 634. The anti-rotating protrusion 634 and the groove 617 are engaged to each other, preventing the abutment 620 from rotating, and guiding it to be oriented in a constant direction. Though as shown in FIG. 15, the anti-rotating protrusion 634 and the groove 617 are formed in a semi-circular shape, they are also formed in various shapes such as a quadrangle, a triangle, or the like.

The sticking portion 632 is formed in a truncated circular conical shape corresponding to the sticking groove 616, supporting the abutment 620, and, in addition, is moved along the inner surface of the sticking groove 616, causing the abutment 620 to be easily separated.

The first screw hole 624 is formed on the center of the abutment 620. The screw 640 is tightened to a female screw hole of the fixture 610 through the first screw hole 624, so that the abutment 620 and the fixture 610 are engaged to each other. Also, since the prosthetic appliance 650 of the SCRP implant 600 comprises a second screw hole 654, the bonded abutment 620 and prosthetic appliance 650 can be separated from the fixture 610.

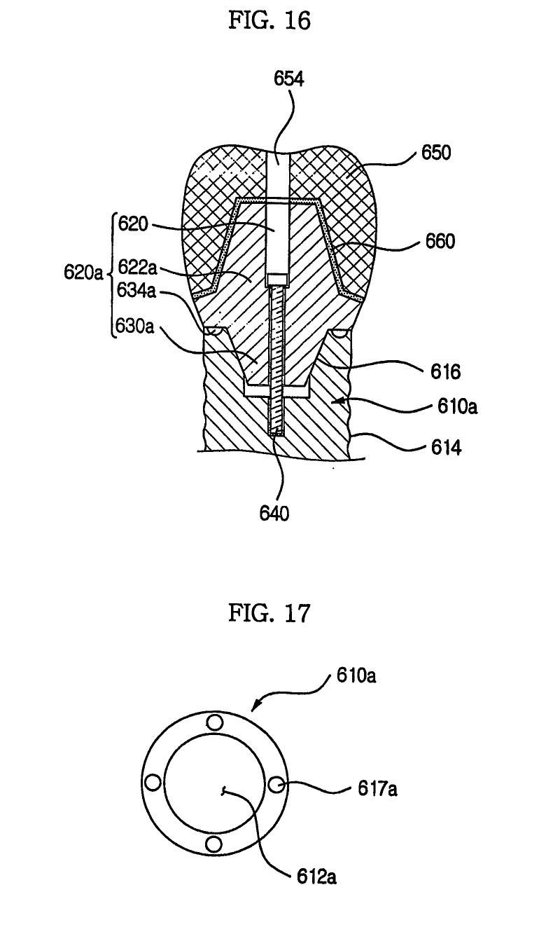

FIG. 16 is a sectional view of an SCRP abutment according to an embodiment similar to, but different from, Embodiment 6, and FIG. 17 is a top view of a fixture.

Referring to FIGS. 16 and 17, the SCRP implant according to the present embodiment comprises a fixture 610a, an abutment 620a, the screw 640 and the prosthetic appliance 650. The explanation with regard to the screw 640 and the prosthetic appliance 650 except the fixture 610a and the abutment 620a may refer to the explanations of the previous embodiment.

The fixture 610a comprises the joining groove 612a for receiving a joining projection 630a, wherein the joining groove 612a has the sticking groove 616 formed in a trumpet shape. At least one groove 617a is formed around the inlet of the joining groove 612a.

The abutment 620a comprises the body 622a and the joining projection 630a, wherein the first screw hole 624 is formed through the body 622a and the joining projection 630a. The joining projection 630a comprises the sticking portion and the anti-rotating protrusion 634a. The sticking portion is formed in a truncated circular conical shape corresponding to the sticking groove 616, and the anti-rotating protrusion 634a is formed adjacently around the sticking portion. For these, the body 622a comprises a gingiva portion supported by a platform of the fixture 610a, and the anti-rotating protrusion 634a is formed at the bottom of the gingiva portion. The anti-rotating protrusion 634a and the groove 617a are engaged to each other, limiting the rotation of the abutment 620a, and guiding the abutment 620a to be oriented in a constant direction. As shown in FIG. 16, though the anti-rotating protrusion 634a may be formed in a small circular conical shape, it may be also formed in various shapes such as a semi-sphere, a cylinder, and the like. The sticking portion is formed in a truncated circular conical shape corresponding to the sticking groove 616, supporting the abutment 620a, and, in addition, is moved along the inner surface of the sticking groove 616, causing the abutment 620a to be easily separated.

The first screw hole 624 is formed on the center of the abutment 620a. The screw 640 is tightened to the female screw hole of the fixture 610a through the first screw hole 624, so that the abutment 620a and the fixture 610a are engaged to each other. Also, since the prosthetic appliance 650 of the SCRP implant comprises the second screw hole 654, the screw 640 can be loosened through the first and the second screw holes 624, 654, and then the bonded abutment 620a and prosthetic appliance 650 can be separated from the fixture 610a.

### EMBODIMENT 7

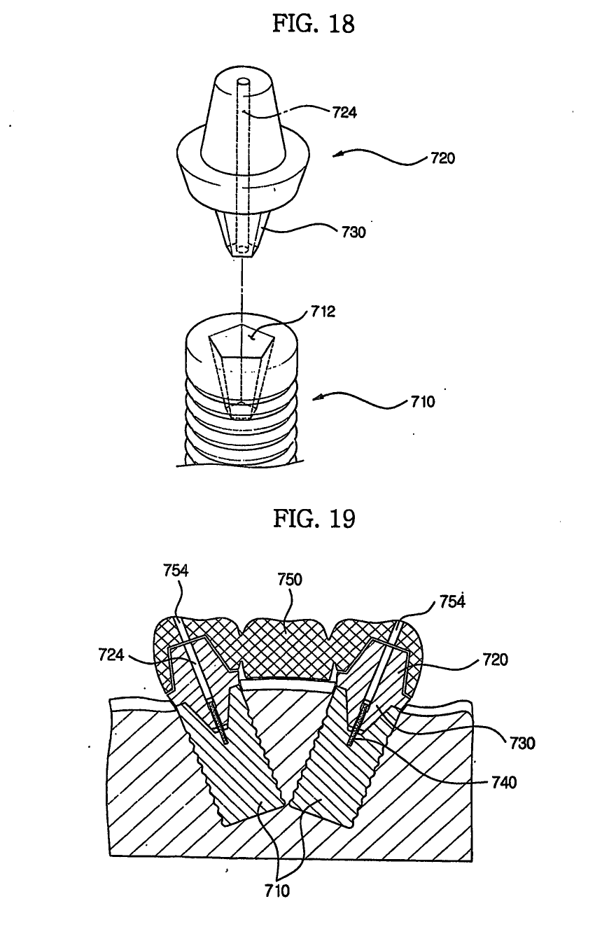

FIG. 18 is an exploded perspective view for explaining a SCRP implant according to Embodiment 7 of the present invention and an abutment used therein, and FIG. 19 is a sectional view for explaining a separating process of the SCRP implant according to Embodiment 7.

Referring to FIGS. 18 and 19, the SCRP implant comprises a fixture 710, an abutment 720, a screw 740 and a prosthetic appliance 750.

A joining groove 712 is formed on the upper end of the fixture 710, wherein the joining groove 712 has an inlet in a pentagonal shape, and a truncated pentagonal pyramidal groove is formed inside the fixture 710. The abutment 720 comprises a joining projection 730 corresponding to the joining groove 712. The joining projection 730 also protrudes from a lower portion of a body 722 and is formed in a truncated pentagonal pyramidal shape, and is inserted into the joining groove 712 to be stuck to the inner surface of the joining groove 712. Due to the joining groove 712, since the joining projection 730 is prevented from rotating, the abutment 720 can be repositioned to be always oriented in a constant direction with respect to the fixture 710, and when the abutment 720 is repositioned after separated from the fixture 710, it is possible to set the direction of the abutment 720 precisely.

The joining projection 730 comprises a sticking portion and anti-rotating portion integrally formed correspondingly to the joining groove 712. If a sticking portion and an anti-rotating portion are particularly distinguished, side surfaces of the truncated pyramid may correspond to the sticking portion and intersecting portions of the truncated pyramid may correspond to the sticking portion.

As shown in FIG. 19, the abutments 720 are positioned at the fixtures 710, which are implanted slantingly with respect to each other, respectively, the fixtures 710 and the abutments 720 are engaged with the screws 740 through the first screw holes 724, and the prosthetic appliance 750 is bonded and fixed to the bonding portions of the abutments 720 with dental cement 760.

The prosthetic appliance 750 is formed with second screw holes 754 corresponding to the first screw holes 724, and can be separated by loosening the screws 740 through the second screw holes 754. In the SCRP implant according to the present embodiment, since the abutments 720 and the prosthetics appliance 750 are bonded by using the dental cement 760, the passive fit can be achieved. Furthermore, the screws 740 may be easily released through the first and the second screw holes 724, 754, and after the screws 740 are released, the prosthetic portion, which is the bonded abutments 720 and prosthetic appliance 750, can be easily separated.

Furthermore, since the joining projections 730 of the abutments 720 are formed in a truncated pentagonal pyramidal shape, when the prosthetic portion is separated, each of the abutments 720 can be easily get off from the fixtures 710 without interference.

Though the joining groove 712 and the joining projection 730 are formed in the truncated pentagonal pyramidal shape, the truncated pyramidal shape may be diversely selected by the designer, changed to a hexagonal or octagonal pyramidal shape, and also modified as equal division or unequal division thereof.

### EMBODIMENT 8

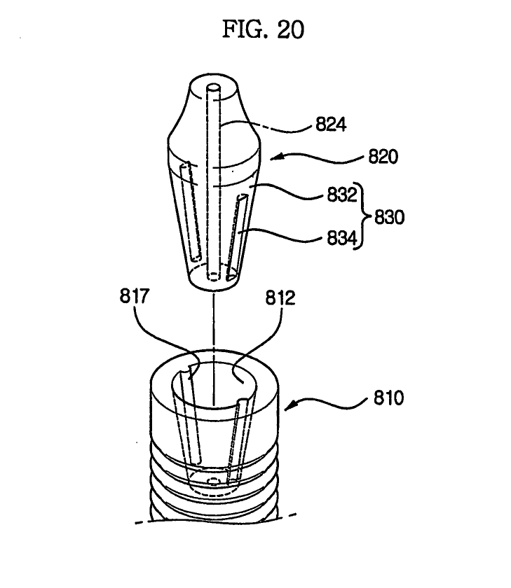

FIG. 20 is an exploded perspective view for explaining a SCRP implant according to Embodiment 8 of the present invention and an abutment used therein.

Referring to FIG. 20, the SCRP implant comprises a fixture 810, an abutment 820, a screw and a prosthetic appliance.

A joining groove 812 is formed in the upper end of the fixture 810, wherein the joining groove 812 is formed in a truncated circular conical shape. The abutment 820 comprises a joining projection 830 formed in a truncated circular conical shape correspondingly to the joining groove 812. The joining projection 830 comprises a truncated circular conical sticking portion 832 and anti-rotating uneven portions 834 formed in the side surface of the sticking portion 832. In the present embodiment, two opposite grooves 817 are formed in the inner surface of the joining groove 812 in an up and down direction, and the anti-rotating uneven portions 834 are formed in a projection shape elongated upward and downward correspondingly to the protrusions 817. The sticking portion 832 is stuck to the inner surface of the joining groove 812 to support the abutment 820, and the anti-rotating uneven portions 834 are engaged to the grooves 817 to prevent the abutment 820 from rotating and to cause the repositioned direction of the abutment 820 to be equal to that before separation.

In the same manner as FIG. 19 of Embodiment 7, each of the abutments 820 according to the present embodiment is engaged to each of the fixtures 810, wherein two to four fixtures constitute a set and are implanted slantingly with respect to each other. After the abutments 820 are engaged with the screws through the first screw holes 824, the prosthetic appliance and the abutments 820 may be easily bonded with the dental cement. Furthermore, since the screws can be easily loosened through second screw holes, the prosthetic appliance and abutments 820 can be simply separated from the fixtures 810.

Furthermore, the joining projections 830 of the abutments 820 are formed in a truncated circular conical shape, so that leading inclined surfaces are formed. The leading inclined surfaces provide allowance spaces between the abutments 820 and the fixtures 810, so that the abutments 820 can be easily get off from the fixtures 810 without interference when the prosthetic portion is separated.

In the present embodiment, though the grooves 817 and the anti-rotating uneven portions 834 have a cross section of semi-sphere, they may also have the cross sections of various shapes such as a quadrangle and a triangle. Under the fundamental rule for preventing the relative rotation, their length, depth, height, or the like may be diversely changed.

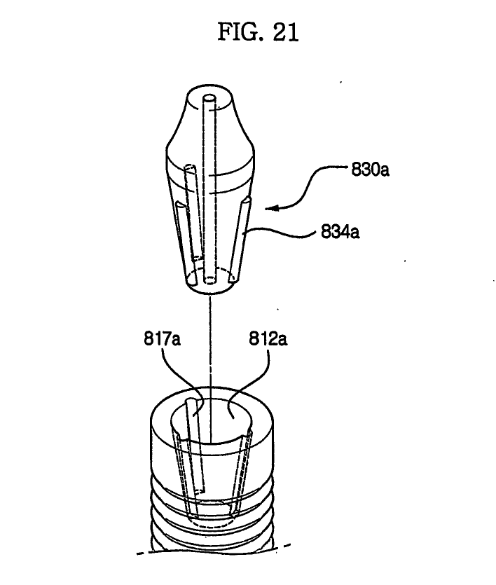

FIG. 21 is an exploded perspective view for explaining an SCRP implant according to an embodiment similar to, but different from, Embodiment 8 and an abutment used therein. In the SCRP implant of FIG. 21, protrusion-shaped anti-rotating uneven portions 834a are formed in the joining projection 830a, and correspondingly thereto, groove-shaped protrusions 817a are formed in the inner surface of joining grooves 812a. Since the other functions and structures are substantially equal to those of Embodiment 8, explanations and drawings of Embodiment 8 may be referred to, and repetitional contents may be omitted.

Contrary to Embodiment 8, though the anti-rotating uneven portions 834a are formed concavely in a protrusion shape and the grooves 817a are formed in the inner surface of the joining groove 812a, fundamentally, the functions of the anti-rotating uneven portions 834a and the grooves 817a are nearly equal to those of the anti-rotating uneven portions 834 and the grooves 817 of Embodiment 8

### EMBODIMENT 9

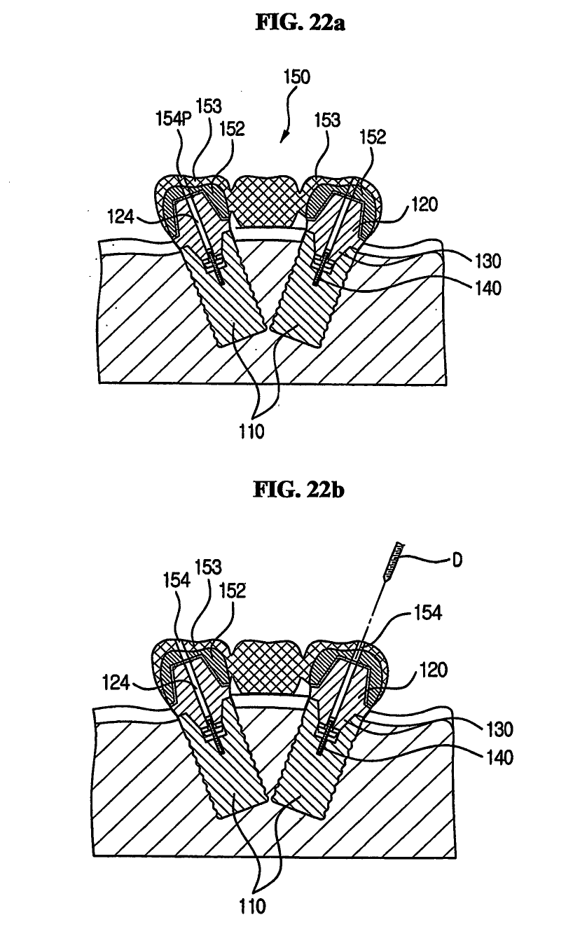

FIG. 22a is a sectional view of an SCRP implant according to Embodiment 9 of the present invention, and FIG. 22b is a sectional view for explaining a separating process of the SCRP implant according to Embodiment 9.

Referring to FIG. 22a, the SCRP implant according to Embodiment 9 comprises the fixtures 110, the abutments 120, the screws 140 and the prosthetic appliance 150. The fixture 110, the abutment 120 and the screw 140 except the prosthetic appliance 150 may refer to the explanations and drawings of Embodiment 1, and repetitional contents may be omitted. For reference, though the present embodiment is explained with the limitation to the SCRP implant of Embodiment 1, features of the present embodiment may be easily applied to the SCRP implant of the other embodiments by the below description.

A joining groove is formed in the upper surface of the fixture 110, and the joining projection 130 of the abutment 120 also comprises the sticking portion and the anti-rotating portion. The first screw hole 124 is formed on the center of the abutment 120, and the screw 140 is engaged to the fixture 110 through the first screw hole 124.

The prosthetic appliance 150 is fabricated of a two-layered structure of a metal framework 152 and a porcelain 153. The metal framework 152 is formed with a hole corresponding to the first screw hole 124, and the porcelain 153 is formed on the metal framework 152 in the form of a tooth. Generally, although the conventional internal prosthetic appliance has a structure of a metal framework and a porcelain, the hole is not formed in the metal framework. Contrary to this, in the prosthetic appliance 150 of the SCRP implant according to the present embodiment, the metal framework 152 is formed with the hole. Since the layer of the porcelain 153 is formed on the metal framework 152 with the hole formed, immediately after treatment, since a portion 154P corresponding to the second screw hole is not exposed, an aesthetic appearance can be achieved, and the foreign body sensation, which a patient may feel immediately after treatment, can be considerably reduced.

Referring to FIG. 22a, the second screw holes 154 may be formed hereafter by using a delicate drill D, so that the screws 140 can be easily separated through the first and the second screw holes 124, 154. The treatment method of the present embodiment, which is a modification of the treatment method of the SCRP implant according to Embodiment 1, has the feature that the second screw holes 154 are formed hereafter.

By forming the second screw holes 154, the boned abutments 120 and prosthetic appliance 150 can be easily separated from the fixtures 110, and the abutments 120 and prosthetic appliance 150 can be also easily remounted to the fixtures 110.

The outer surfaces 122 of the abutments 120 approximately corresponds to, but does not completely accord with, inner surfaces of the metal frameworks 152 in shape. That is to say, like the cement retained prosthesis, by providing allowance spaces between the abutments 120 and prosthetic appliance 150, the prosthetic appliance 150 can be passively fitted to the abutments 120. At this time, the dental cement is interposed between the abutments 120 and the prosthetic appliance 150, so that the abutments 120 and the prosthetic appliance 150 are bonded.

The implant according to the present embodiment is usefully employed in the case that the second screw holes 154 must not be formed, as an incisor, and usefully applied to the case such that cement can be easily removed without removing the prosthetic appliance in molar teeth. In this case, different points from the cement retained prosthesis are that when the SCRP abutments 120 are employed together, the SCRP implant may cause the features of the SCRP abutment 120 to be prominent, and the marks to find the second screw holes 154 may be represented.

Though the prosthetic appliance 150 consists of the metal frameworks and the porcelain in the present embodiment, it consists of only the porcelain without the metal frameworks. Since after the prosthetic appliance is bonded, portions corresponding to the second screw holes are not exposed, an aesthetic appearance can be achieved.

### INDUSTRIAL APPLICABILITY

According to the present invention, the methods for treating the SCRP implant adopt the advantages of both of the screw retained type and the cement retained type and solve the disadvantages of both types, so that most of the conditions, which an implant prosthesis requires, are satisfied.

That is to say, with the present invention, the passive fit between the implant and the prosthetic appliance can be easily achieved; since tightening the screw can be properly adjusted, the screw does not often come loose, and can be retightened without damage to the prosthetic appliance when the screw is loosened; the prosthetic appliance is easily separated and mounted compared with the cement retained type; missing potential of the prosthetic appliance is decreased since the permanent cement can be used without a burden; and it is possible to be applied in a case of short intermaxillary distance. Furthermore, cement of subgingival can be easily removed; the border of the prosthetic appliance can be polished; the manual operational processes and clinical procedures are simple; time and cost can be considerably saved; due to fewer limitations, selection of kinds of metals for the prosthetic appliance is free; it is very advantageous in an instant treatment for the implant; it is possible to be applied to most cases; the prosthetic appliance can be separated without damage and bonded again even when the cement in one of the abutments in plural implant prostheses is weak or bad; and since a large force is not applied to the implant though the screw is strongly tightened, the screw can be tightened by the required torque even in an implant of weak ossein.

Furthermore, in the abutment according to the present invention, the sticking groove and the allowance groove are formed in the receiving portion, which is engaged to the fixture. Therefore, the abutment can be repositioned in the fixture by the sticking groove; and due to the allowance groove, even after the abutment and the prosthetic appliance are bonded, they can be easily separated from and remounted to the fixture. Especially, in the case that two or more abutments are integrally fixed to a prosthetic appliance, the allowance grooves provide the allowance spaces in order for the joining projections of the fixtures to be easily separated, and the sticking grooves guide the abutments to be positioned in the fixtures correctly.

Furthermore, since the prosthetic appliance and abutment can be easily separated from and remounted to the fixture, when the implant is broken or the screw is loosened, the implant can be easily repaired, mended and replaced.

Furthermore, since the abutment according to the present invention may be embodied on the basis of the structure of the most conventional abutment, the present invention is very economical.

As described above, though the present invention is explained referring to the preferable embodiments, it is understood by one skilled in the art that the present invention can be modified or revised without departing from the spirit or scope of the present invention described in the following claims.

1. A method for treating a screw-cement retained prosthesis, comprising the steps of:
providing an abutment, which comprises a joining projection formed on the lower portion of a body of the abutment and a first screw hole formed upward and downward through the body;
repositioning and inserting the joining projection into a joining groove, which is formed in an upper portion of a fixture correspondingly to the joining projection;
engaging the abutment to the fixture by using a screw corresponding to the first screw hole;
providing a prosthetic appliance including a second screw hole formed correspondingly to the first screw hole; and
bonding the prosthetic appliance and the abutment by interposing dental cement between the abutment and the prosthetic appliance.

2. The method as claimed in claim 1, further comprising removing the screw through the second screw hole; separating the bonded prosthetic appliance and abutment from the fixture; removing the remaining cement; and polishing the border of the prosthetic appliance.

3. The method as claimed in claim 1, wherein the joining projection is provided with a sticking portion, which is entirely or partially stuck to the joining groove formed in the fixture and then supports the abutment, and an anti-rotating portion, which is formed adjacently to the sticking portion and then limits a relative rotation of the abutment with respect to the fixture, a leading inclined surface is provided which is formed with the sticking portion or the anti-rotating portion partially removed, due to the leading inclined surface, an allowance space is provided between the joining projection and the joining groove, and using the allowance space, the prosthetic appliance and abutment are easily separated from the fixture.

4. The method as claimed in claim 1, wherein the joining groove and the joining projection are provided which are formed in a polygonal cylindrical shape the cross-section of which is a polygon, and using a leading inclined surface formed with the joining projection partially removed, the prosthetic appliance and the abutment are easily separated from the fixture.

5. The method as claimed in claim 1, wherein each of a plurality of the abutments is engaged to each of the fixtures that are implanted at predetermined intervals, and in the step of providing the prosthetic appliance, the prosthetic appliance is bonded to the abutments at once by providing the prosthetic appliance, which corresponds to the respective abutments and is integrally formed with the abutments.

6. A method for treating a screw-cement retained prosthesis, comprising the steps of:
providing an implant wherein an abutment, which comprises a joining projection formed in the lower portion of an abutment body and a first screw hole formed upward and downward through the body, is engaged to a fixture with a screw, and a prosthetic appliance is bonded to the abutment;
forming a second screw hole in the prosthetic appliance correspondingly to the first screw hole; and
separating the prosthetic appliance and abutment from the fixture by loosening the screw through the first and the second screw holes.

7. The method as claimed in claim 6, wherein the prosthetic appliance comprises a metal framework, which is formed at the lower portion thereof and directly receives the abutment, and a porcelain, which is formed on the metal framework, and a hole corresponding to the first screw hole is formed in the metal framework in order to form the second screw hole.

8. The method as claimed in claim 6, wherein the prosthetic appliance is constituted by a porcelain.

9. An abutment for a screw-cement retained prosthesis, comprising:
a body, which includes a bonding portion bonded to a prosthetic appliance and is formed with a screw hole upward and downward through the body; and
a joining projection, the joining projection formed in the lower portion of the body, and the joining projection comprising a sticking portion, which is entirely or partially stuck to a joining groove formed in the upper portion of a fixture to support the body, an anti-rotating portion, which is formed adjacently to the sticking portion to limit a relative rotation of the body with respect to the fixture, and a leading inclined surface, which is formed with the sticking portion or the anti-rotating portion partially removed,
wherein due to the leading inclined surface, an allowance space is formed between the joining projection and the joining groove, and due to the allowance space, the prosthetic appliance and body are easily separated from the fixture.

10. The abutment as claimed in claim 9, wherein the sticking portion is formed at the lower end of the body in a truncated circular conical shape correspondingly to the joining groove, which is formed in a truncated circular conical shape, the anti-rotating portion, which is formed at the lower end of the sticking portion in an elliptical or polygonal cylindrical shape, is formed integrally with the sticking portion, and the leading inclined surface is provided by partially removing the anti-rotating portion in an inclined direction.

11. The abutment as claimed in claim 9, wherein the sticking portion is formed at the lower end of the body in a truncated circular conical shape correspondingly to the joining groove, which is formed in a truncated circular conical shape, the anti-rotating portion, which is formed at the lower end of the sticking portion in an elliptical or polygonal cylindrical shape, is formed integrally with the sticking portion, and the leading inclined surface is provided by partially removing the sticking portion and the anti-rotating portion in an inclined direction.

12. The abutment as claimed in claim 9, wherein the sticking portion and the anti-rotating portion are integrally formed at the lower end of the body in a polygonal cylindrical shape correspondingly to the joining groove, which is formed in a polygonal cylindrical shape, and the leading inclined surface is provided by partially removing the sticking portion and the anti-rotating portion in an inclined direction.

13. The abutment as claimed in claim 9, wherein the sticking portion is formed at the lower end of the body in a circular cylindrical shape corresponding to the joining groove, which is formed in a circular cylindrical shape, and the anti-rotating portion comprises at least one anti-rotating uneven portion formed in the side surface of the sticking portion correspondingly to uneven portion formed in the inner surface of the joining groove.

14. The abutment as claimed in claim 9, wherein the sticking portion and the anti-rotating portion are integrally formed at the lower end of the body in a truncated pyramidal shape correspondingly to the joining groove, which is formed in a truncated pyramidal shape

15. The abutment as claimed in claim 9, wherein the sticking portion is formed at the lower end of the body in a truncated circular conical shape correspondingly to the joining groove, which is formed in a truncated circular conical shape, the anti-rotating portion comprises at least one anti-rotating uneven portion formed in a side surface of the sticking portion correspondingly to uneven portion formed in the inner surface of the joining groove.

16. The abutment as claimed in claim 9, wherein the body comprises a gingiva portion supported by a platform of the fixture, the sticking portion of the joining projection is formed at the lower end of the body correspondingly to the shape of the joining groove, the anti-rotating portion comprises at least one projection formed in the bottom surface of the gingiva portion, the projection is engaged to a groove formed in the platform of the fixture to limit a rotation of the abutment, the leading inclined surface is provided by removing the sticking portion partially.

17. An implant for a screw-cement retained prosthesis, comprising:
a fixture wherein a joining groove is formed in the upper portion of the fixture; and
an abutment comprising:
a body, which includes a bonding portion bonded to a prosthetic appliance and is formed with a screw hole upward and downward through the body; and
a joining projection, the joining projection formed in the lower portion of the body, and the joining projection comprising a sticking portion, which is entirely or partially stuck to the joining groove to support the body, an anti-rotating portion, which is formed adjacently to the sticking portion to limit a relative rotation of the body with respect to the fixture, and a leading inclined surface, which is formed with the sticking portion or the anti-rotating portion partially removed,
wherein due to the leading inclined surface, an allowance space is formed between the joining projection and the joining groove, and due to the allowance space, the prosthetic appliance and body are easily separated from the fixture.

18. The implant as claimed in claim 17, wherein the joining groove is formed in a truncated pyramidal shape, and the sticking portion and the anti-rotating portion are integrally formed at the lower end of the body in a truncated pyramidal shape correspondingly to the joining groove.

19. The implant as claimed in claim 17, wherein the joining groove is formed in a truncated circular conical shape, and the sticking portion is formed at the lower end of the body in a truncated circular conical shape correspondingly to the joining groove, the anti-rotating portion comprises at least one anti-rotating uneven portion formed in the side surface of the sticking portion correspondingly to uneven portion formed in the inner surface of the joining groove.
